(19) United States
(12) Patent Application Publication
(10) Pub. No.: US 2015/0289546 A1
(43) Pub. Date: Oct. 15, 2015

(54) PUFFED SNACK FOOD AND INFUSED PUFFED SNACK FOOD

(71) Applicant: MEJI CO. LTD, koto-ku, Tokyo (JP)

(72) Inventors: Fumito Miya, Tsurugashima-shi (JP); Masakazu Nasu, Tsurugashima-shi (JP); Terutaro Shimamura, Tokyo (JP); Takahiro Miura, Tsurugashima-shi (JP); Hiromitsu Iwanami, Tsurugashima-shi (JP)

(73) Assignee: MEJI CO., LTD., Koto-ku, Tokyo (JP)

(21) Appl. No.: 14/395,853

(22) PCT Filed: Apr. 25, 2013
(86) PCT No.: PCT/JP2013/062230

§ 371 Date: Oct. 21, 2014

(30) Foreign Application Priority Data
Apr. 26, 2012 (JP) 2012-101001

(51) Int. Cl. A23L 1/18

(52) U.S. Cl. CPC A23L 1/1805; A23V 2002/00

(57) ABSTRACT

Provided is a cylindrical puffed snack food comprising a plurality of inner rope parts and a plurality of outer rope parts,

wherein the inner rope parts and the outer rope parts are formed by using a die head comprising a circular inner nozzle part and an annular outer nozzle part provided around the inner nozzle part,

wherein the inner nozzle part comprises a plurality of inner nozzle recesses, which have arc-shaped cross sections and are disposed around an outer circumferential surface facing the outer nozzle part in the circumferential direction,

the outer nozzle part comprises a plurality of outer nozzle recesses, which have arc-shaped cross sections and are disposed around an inner circumferential surface facing the inner nozzle part in the circumferential direction,

the outer nozzle part is provided in such a way as to be continuously rotatable around the inner nozzle part, and

a total length of the arcs of the plurality of inner nozzle recesses is ⅓ or more and ¾ or less of a length of a circumference of the inner nozzle part, and

wherein the cylindrical puffed snack food is obtained by a method comprising a step of molding a puffed snack ingredient by extrusion through the die head.

### TECHNICAL FIELD

The present invention relates to a puffed snack food having a light texture, despite its complex configuration. The present invention relates to an impregnated puffed snack food, which is a puffed snack food having a light texture, despite its complex configuration, further impregnated with an oil and fat based confectionery material.

### BACKGROUND ART

Conventionally, various puffed snack foods have been studied.

### CITATION LIST

### Patent Literature

Patent Literature 1: Japanese Patent Laid-Open No. H11-196770
Patent Literature 2: Japanese Utility Model Registration No. 3118586
Patent Literature 3: Japanese Patent Laid-Open No. S63-68038

### SUMMARY OF INVENTION

### Technical Problem

However, the lighter the texture of puffed snack foods, namely, the less crispy the puffed snack foods, the more the form of the puffed snack foods is limited to a rod or substantially flat form. This is due to the following reasons. That is, the less crispy the puffed snack foods, the more vulnerable they become to impact. The more complex the form of the puffed snack foods, the more likely they come into contact or get tangled with each other during production steps. For these reasons, there is no choice but to adopt an impact-resistant, simple form as mentioned above as a product. Under such circumstances, there is a demand for puffed snack foods with a more attractive appearance.

In view of the foregoing, a novel puffed snack food in a lattice form is under consideration (Patent Literature 1). However, undesirably, the puffed snack food described in Patent Literature 1 also has a hard, crunchy texture, showing a tendency that it is impossible to achieve both a complex configuration and a light texture at the same time.

Impregnating an oil and fat based material, such as chocolate, into puffed snack foods is also under consideration; however, in most cases, the puffed snack foods have a substantially flat form. The outer coat of extrusion-molded puffed snack foods is relatively smooth, which creates a tendency that the oil and fat based material does not easily impregnate into the puffed snack foods. In view of this, there is no choice but to adopt, as a product, a form in which the cross-sectional area into which an oil and fat based material is easily impregnated is widened and the outer coat portion into which an oil and fat based material is not easily impregnated is made thin.

A confectionery in which chocolate is impregnated into openings punched in a confectionery ingredient is under consideration (Patent Literature 2). However, when a confectionery ingredient has a fragile nature or complex a configuration, the confectionery ingredient crumbles when the openings are punched, resulting in failure of achieving both a complex configuration with a light texture and impregnation of chocolate at the same time.

The present invention has been accomplished in view of the foregoing circumstances, and an object of the present invention is to provide a puffed snack food having an attractive appearance and a complex form, yet having a light texture, despite its complex form.

### Solution to Problem

In order to achieve the aforementioned object, production of a cylindrical puffed snack food having a complex form was studied. As a result, it was found that a cylindrical puffed snack food having a specific form had a light texture, despite its complex form.

That is, the present invention has the following features.

(1) A cylindrical puffed snack food comprising a plurality of inner rope parts and a plurality of outer rope parts,

wherein the inner rope parts and the outer rope parts are formed by using a die head comprising a circular inner nozzle part and an annular outer nozzle part provided around the inner nozzle part,

wherein the inner nozzle part comprises a plurality of inner nozzle recesses, which have arc-shaped cross sections and are disposed around an outer circumferential surface facing the outer nozzle part in the circumferential direction,

the outer nozzle part comprises a plurality of outer nozzle recesses, which have arc-shaped cross sections and are disposed around an inner circumferential surface facing the inner nozzle part in the circumferential direction,

the outer nozzle part is provided in such a way as to be continuously rotatable around the inner nozzle part, and

a total length of the arcs of the plurality of inner nozzle recesses is ⅓ or more and ¾ or less of a length of a circumference of the inner nozzle part, and

wherein, the cylindrical puffed snack food is obtained by a method comprising a step of molding a puffed snack ingredient by extrusion through the die head.

(2) The cylindrical puffed snack food according to (1), wherein a diameter of the inner rope part and a diameter of the outer rope part are each 0.5 mm to 5 mm.
(3) The cylindrical puffed snack food according to (1) or (2), wherein the puffed snack ingredient comprising 50 parts by weight to 100 parts by weight of a starchy ingredient, 0.1 part by weight to 10 parts by weight of a protein ingredient, 0.5 part by weight to 10 parts by weight of an oil and fat ingredient, and 8 parts by weight to 20 parts by weight of water is puffed by an extruder provided with the die head.
(4) An impregnated puffed snack food, which is a cylindrical puffed snack food comprising a plurality of inner rope parts and a plurality of outer rope parts impregnated with an oil and fat based confectionery material,

wherein the inner rope parts and the outer rope parts are formed by using a die head comprising a circular inner nozzle part and an annular outer nozzle part provided around the inner nozzle part,

wherein the inner nozzle part comprises a plurality of inner nozzle recesses, which have arc-shaped cross sections and are disposed around an outer circumferential surface facing the outer nozzle part in the circumferential direction,

the outer nozzle part comprises a plurality of outer nozzle recesses, which have arc-shaped cross sections and are disposed around an inner circumferential surface facing the inner nozzle part in the circumferential direction,

the outer nozzle part is provided in such a way as to be continuously rotatable around the inner nozzle part, and

a total length of the arcs of the plurality of inner nozzle recesses is ⅓ or more and ¾ or less of a length of a circumference of the inner nozzle part, and

wherein, the cylindrical puffed snack food is obtained by a method comprising a step of molding a puffed snack ingredient by extrusion through the die head.

(5) The impregnated puffed snack food according to (4), wherein a diameter of the inner rope part and a diameter of the outer rope part are each 1 mm to 5 mm.
(6) The impregnated puffed snack food according to (4) or (5), wherein the puffed snack ingredient comprising 50 parts by weight to 100 parts by weight of a starchy ingredient, 0.1 part by weight to 10 parts by weight of a protein ingredient, 0.5 part by weight to 10 parts by weight of an oil and fat ingredient, and 8 parts by weight to 20 parts by weight of water is puffed by an extruder provided with the die head.

### Advantageous Effects of Invention

The present invention can provide a puffed snack food having a complex form, which has a light texture, despite its complex form.

### BRIEF DESCRIPTION OF DRAWINGS

FIG. 1 is a set of schematic views illustrating the cylindrical puffed snack food according to the present embodiment.

FIG. 2 is a set of schematic plan views looking down the cylindrical puffed snack food according to the present embodiment from the upper part of FIG. 1(a).

FIG. 3 is a schematic views illustrating the die head according to the present embodiment.

FIG. 4 is a set of photographs of the cylindrical puffed snack food obtained in Example 3.

FIG. 5 is a set of photographs of the cylindrical puffed snack food obtained in Example 5.

FIG. 6 is a set of photographs of the cylindrical puffed snack food obtained in Example 7.

### DESCRIPTION OF EMBODIMENTS

The embodiments of the present invention will be described below in detail; however, the present invention is not limited to these embodiments.

According to the present embodiment, a puffed snack food refers to a food having a porous void space inside, and examples thereof include a food obtained by cooking or puffing a puffed snack ingredient by an extruder. An impregnated puffed snack food refers to a food obtained by impregnating an oil and fat based confectionery material into a puffed snack food.

The cylindrical puffed snack food according to the present embodiment is a cylindrical puffed snack food comprising a plurality of inner rope parts and a plurality of outer rope parts,

wherein the inner rope parts and the outer rope parts are formed by using a die head comprising a circular inner nozzle part and an annular outer nozzle part provided around the inner nozzle part,

wherein the inner nozzle part comprises a plurality of inner nozzle recesses, which have arc-shaped cross sections and are disposed around an outer circumferential surface facing the outer nozzle part in the circumferential direction,

the outer nozzle part comprises a plurality of outer nozzle recesses, which have arc-shaped cross sections and are disposed around an inner circumferential surface facing the inner nozzle part in the circumferential direction,

the outer nozzle part is provided in such a way as to be continuously rotatable around the inner nozzle part, and

a total length of the arcs of the plurality of inner nozzle recesses is ⅓ or more and ¾ or less of a length of a circumference of the inner nozzle part, and

wherein the cylindrical puffed snack food is obtained by a method comprising a step of molding a puffed snack ingredient by extrusion through the die head.

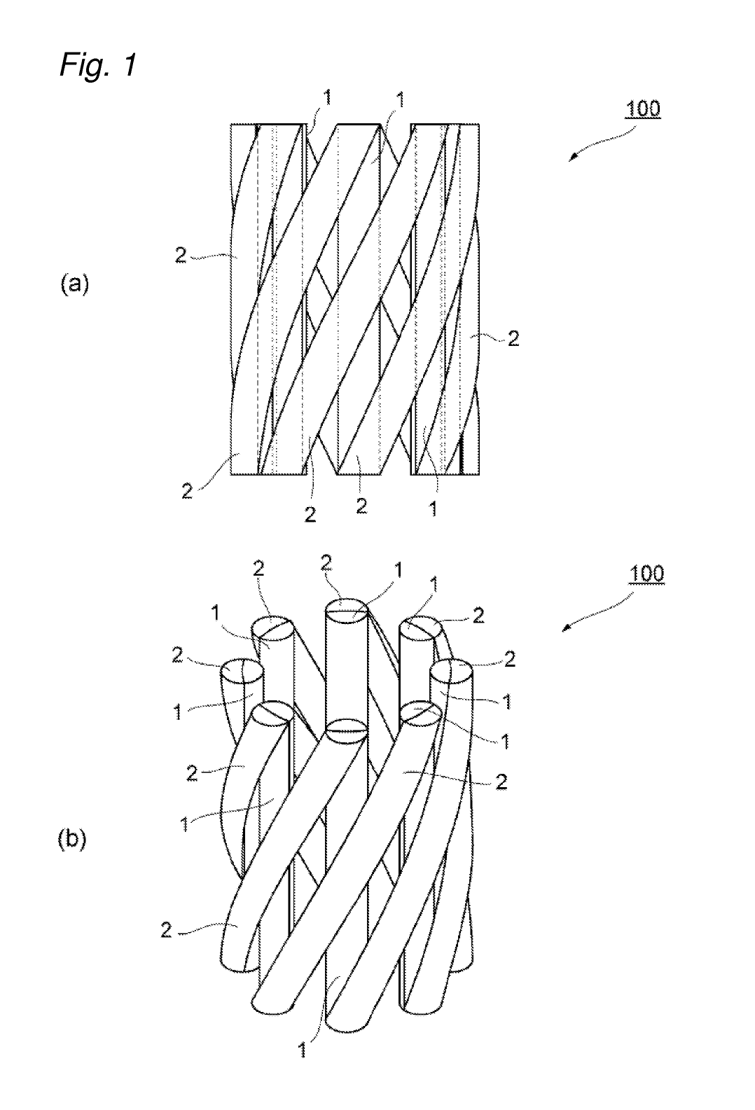

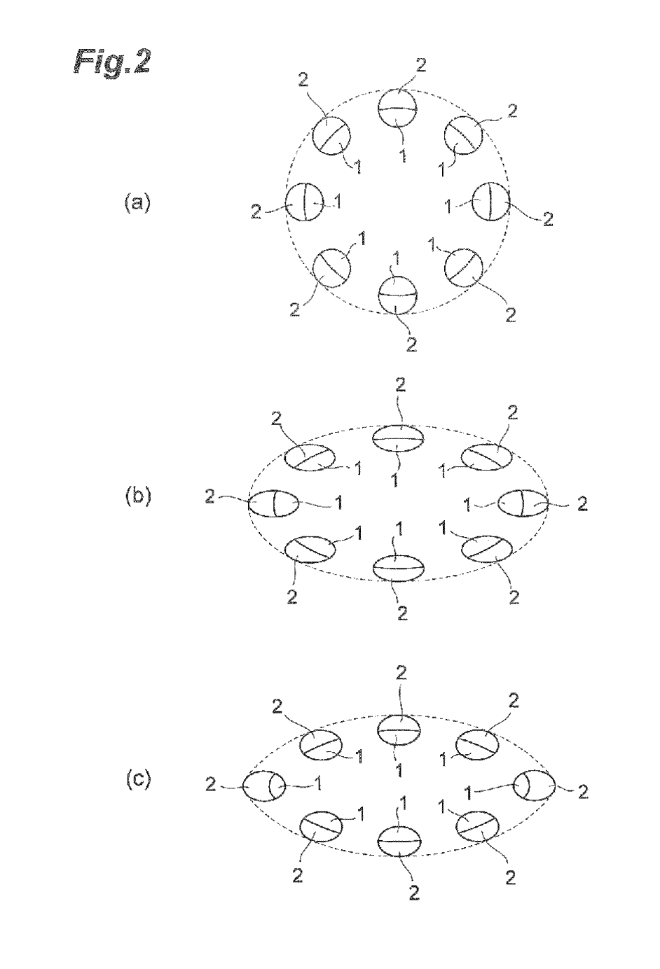

FIG. 1 is a set of schematic views illustrating the cylindrical puffed snack food according to the present embodiment. FIG. 1(a) is a plan view looking at the cylindrical puffed snack food from the outer periphery, and FIG. 1(b) is a perspective view of the cylindrical puffed snack food. A cylindrical puffed snack food 100 comprises a plurality of inner rope parts 1 and a plurality of outer rope parts 2 which intersect with the inner rope parts 1 while in contact with the plurality of outer rope parts 2. According to one embodiment, because the inner rope parts 1 and the outer rope parts 2 are generally concentrically laminated, the cylindrical puffed snack food 100 has a generally cylindrical form as a whole (FIG. 1 and FIG. 2(a)). The form of the cylindrical puffed snack food 100 as looked down from the upper part of FIG. 1(a) is not limited to a circle, but may be an oval or lens form (FIGS. 2(b) and (c)).

The inner rope part 1 and outer rope part 2, both of which constitute the cylindrical puffed snack food 100, may each present in plural numbers; however, the numbers of the inner rope part 1 and outer rope part 2 are preferably each 4 or more from the viewpoint of a complex form, and preferably each 20 or less from the viewpoint of a light texture. In other words, the numbers of the inner rope part 1 and outer rope part 2 are preferably each 4 to 20. The numbers of the inner rope part 1 and outer rope part 2 are more preferably each 6 to 16. From the viewpoint of enabling the retention of an impact-resistant complex form, the number of the inner rope part 1 is preferably equal to that of the outer rope part 2. From the viewpoint of not impairing a light texture, the number of the inner rope part 1 is preferably greater than that of the outer rope part 2.

From the viewpoint of enabling the retention of an impact-resistant complex form with a light texture, the diameters of the inner rope part 1 and outer rope part 2, both of which constitute the cylindrical puffed snack food 100, are preferably each 0.5 mm to 5 mm. When an oil and fat based confectionery material is impregnated into the cylindrical puffed snack food 100, the diameter of each of the rope parts (inner rope part 1 and outer rope part 2) constituting the cylindrical puffed snack food 100 is preferably 1 mm to 5 mm.

The angle at which the inner rope part 1 and outer rope part 2, both of which constitute the cylindrical puffed snack food 100, intersect with each other is preferably 5° to 60°, more preferably 10° to 40°. The number of points of contact at which one outer rope part 2 intersects with each of a plurality of inner rope parts 1 is not particularly limited. When the cylindrical puffed snack food 100 having a long side of 28 mm, which will be described later, is produced using a die head 50 having an inner nozzle diameter D1 of 16 to 32 mm and an opening diameter D2 of 2.0 to 2.4 mm, the number of points of contact at which one outer rope part 2 intersects with each of a plurality of inner rope parts 1 is preferably 3 to 5. A description of the die head 50 will be given later.

The ratio of the short side of the cylindrical puffed snack food 100 to the long side of the cylindrical puffed snack food 100, i.e., short side:long side, is preferably 1:1 to 1:5. More preferably, the above ratio is 1:2 to 1:3. Although the length of the long side of the cylindrical puffed snack food 100 is not particularly limited, it is preferably 10 cm or less, more preferably 1.5 to 5 cm (15 to 50 mm), and even more preferably 2 to 4 cm (20 to 40 mm) from the viewpoint of consuming it as a snack. Here, the length of the short side refers to the horizontal length of the cylindrical puffed snack food of FIG. 1(a), and the length of the long side refers to the vertical length of the cylindrical puffed snack food of FIG. 1(a). For example, when the form of the cylindrical puffed snack food 100 of FIG. 1(a) as looked down from above is a circle, the diameter of a virtual circle indicated by a dotted line in FIG. 2(a) corresponds to the length of the short side. For other example, when the form of the cylindrical puffed snack food 100 of FIG. 1(a) as looked down from above is an oval, the longest diameter of a virtual oval indicated by a dotted line in FIG. 2(b) corresponds to the length of the short side. For further example, when the form of the cylindrical puffed snack food 100 of FIG. 1(a) as looked down from above is a lens form when looked down from above, the length from the left end to the right end of a virtual lens form indicated by a dotted line in FIG. 2(c) corresponds to the length of the short side.

By virtue of having the aforementioned construction, the cylindrical puffed snack food 100 according to the present embodiment can provide a light crispness when chewed and a melt-in-the-mouth characteristic (a texture produced as a food or drink melts in the mouth). And moreover, when the cylindrical puffed snack food 100 is chewed in the mouth, it crumbles in a complex way, thereby giving a unique texture, which is not simply characterized by a crumbly feeling of the food crumbling in a brittle manner. By impregnating an oil and fat based confectionery material into the cylindrical puffed snack food according to the present embodiment, a novel texture can be imparted to the cylindrical puffed snack food. Further, the impregnated puffed snack food according to the present embodiment can provide not only a pleasant crispness, which cannot be felt when the food is dip-coated with an oil and fat based confectionery material, but also such a unique texture that the entire food is disintegrated. That is, according to the present embodiment, a puffed snack food which is, despite its light texture, resistant to impact and capable of retaining an unprecedentedly complex form can be provided. According to the present embodiment, an impregnated puffed snack food which is impregnated with an oil and fat based confectionery material, despite its complex form can be provided. According to the present embodiment, an impregnated puffed snack food having a light texture, despite being impregnated with an oil and fat based confectionery material can be provided.

In order for the cylindrical puffed snack food according to the present embodiment to have the aforementioned construction, it is preferable that a puffed snack ingredient comprising 50 parts by weight to 100 parts by weight of a starchy ingredient, 0.1 part by weight to 10 parts by weight of a protein ingredient, 0.5 part by weight to 10 parts by weight of an oil and fat ingredient, and 8 parts by weight to 20 parts by weight of water is puffed by an extruder.

<1. Ingredients>

Examples of the starchy ingredient include cereals such as wheat flour, barley flour, rye flour, oat flour, corn flour, rice flour, soy flour, buckwheat flour, mashed potatoes, and corn grits. It is also possible to use starches such as corn starch, potato starch, tapioca starch, and waxy corn starch as the starchy ingredient. Further, it is also possible to use processed starch such as a pregelatinized starch product, an acetylated starch derivative, and a phosphate-cross-linked starch derivative as the starchy ingredient. Examples of the starchy ingredient include sugars such as monosaccharides such as glucose and fructose, disaccharides such as sucrose (table sugar and powdered sugar), maltose and lactose, invert sugar, polysaccharides such as dextrin, and sugar syrup.

It is also possible to use protein ingredients, oil and fat ingredients, emulsifiers, amino acids, leavening agents, seasonings, flavors, vitamins, minerals, cellulose, and the like together with the aforementioned starchy ingredient such as the cereals, starches, and sugars.

Examples of the protein ingredient include whole eggs, egg whites, dried whole eggs, dried egg whites, skim milk powder, and powdered milk.

Examples of the oil and fat ingredient include vegetable oils and fats such as shortening, palm oil, palm kernel oil, rapeseed oil, coconut oil, peanut oil, safflower oil, sunflower oil, cottonseed oil, corn oil, soybean oil, and rice oil, and cocoa butter as well as animal oils and fats such as beef tallow, lard, fish oil, whale oil, and milk fat. It is also possible to use processed oil and fat such as those obtained by subjecting the above vegetable oils and fats and animal oils and fats (animal and vegetable oils and fats) to a treatment such as a hydrogenation treatment, a separation treatment, and a transesterification treatment.

Examples of the emulsifiers include sucrose fatty acid ester, glycerol fatty acid ester, sorbitan fatty acid ester, higher fatty acid monoglyceride, and lecithin.

Examples of the oil and fat based confectionery material to be impregnated into the cylindrical puffed snack food include chocolate, fat spread, and praline paste, and those which satisfy various conditions required in the production stage and distribution stage can be used. The chocolate may be any type of chocolate such as sweet chocolate (dark-sweet chocolate), semisweet chocolate (dark-semisweet chocolate), milk chocolate, and white chocolate, and the chocolate does not necessarily have to meet the standards of chocolate as stipulated in the “Fair Competition Code for Proper Labeling of Chocolate Products ” certified by Japan Fair Trade Commission.

Examples of the ingredient of the oil and fat based confectionery material include pastes obtained by a process of roasting and grinding such as cocoa mass, peanut paste, almond paste, and pecan nut pasta, and sugars, cereal flours such as wheat flour, powdered milks such as whole milk powder, skim milk powder, and high fat milk powder, emulsifiers, flavors, dyes, cocoa powder, various kinds of starches, nuts, dairy products such as cheese powder, shortening, dried fruits, and animal and vegetable oils and fats.

Examples of the sugars include monosaccharides such as glucose and fructose, disaccharides such as sucrose (table sugar and powdered sugar), maltose and lactose, invert sugar, polysaccharides such as dextrin, and sugar syrup. Further, a high-intensity sweetener such as sucralose and saccharin may also be added.

Examples of the emulsifiers include lecithin, polyglycerol fatty acid ester, glycerol fatty acid ester, organic acid monoglyceride, sorbitan fatty acid ester, sucrose fatty acid ester, propylene glycol fatty acid ester, and polyglycerol condensed ricinoleic acid ester.

Examples of the animal and vegetable oils and fats include non-tempering type and tempering type natural oils and fats. Non-tempering type oils and fats refer to those oils and fats which transform into a semi-stable crystal form (β′ type) simply by cooling, without tempering. Examples of the non-tempering type oils and fats include coconut oil, sal fat soft oil (non-tempering type oil and fat obtained by fractionating sal fat according to melting point), palm kernel oil, and hydrogenated oil. Tempering type oils and fats refer to those oils and fats which do not transform into a stable crystal form (β type) unless they are tempered. Examples of the tempering type oils and fats include vegetable oil and fat such as cocoa butter, fractionated and purified oil and fat of palm oil (obtained by fractionating palm oil according to melting point. Unlike palm kernel oil, the fractionated and purified oil and fat of palm oil have palmitic acid and oleic acid glycerol ester as the major component, and they are also referred to as the medium melting point fraction of palm oil and fat), sal fat, and shear butter.

<2. Production Method>

The cylindrical puffed snack food according to the present embodiment can be produced by, for example, as follows. The ingredients of the puffed snack food (puffed snack ingredients) are put into the feed inlet of an extruder, which are then discharged from nozzle openings of a die head mounted on the tip of the extruder to form the inner rope parts and outer rope parts, whereby a rope-like cylindrical puffed snack is obtained. Although the operating conditions of the extruder may be appropriately set according to the instrument used, when a twin-screw extruder (Model TEM50B, the product of TOSHIBA MACHINE CO., LTD) is used, for example, the feed volume is preferably 30 to 150 kg/hr, the amount of water added is preferably 0.5 to 15.0 kg/hr, the screw rotation speed is preferably 200 to 400 r.p.m., the head pressure is preferably 30 to 150 kgf/cm², and the barrel temperature is preferably 140 to 200° C. The obtained cylindrical puffed snack is cut into 15 to 50 mm pieces, preferably 20 to 40 mm pieces, and left to cool until the product temperature reaches room temperature, whereby the cylindrical puffed snack food can be obtained.

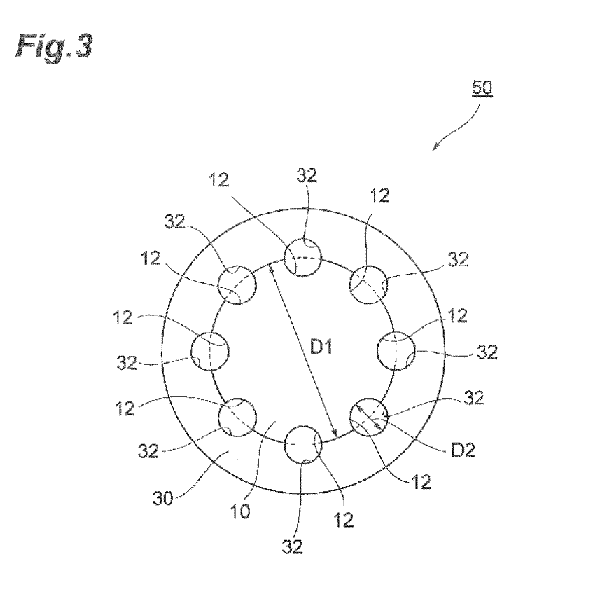

The die head is described here. FIG. 3 is a schematic view illustrating the die head according to the present embodiment. A die head 50 comprises a circular inner nozzle part 10 and an annular outer nozzle part 30 provided around the inner nozzle part 10. The outer nozzle part 30 is slidable relative to the inner nozzle part 10. According to one embodiment, the outer circumferential surface of the inner nozzle part 10 and the inner circumferential surface of the outer nozzle part 30 may be spaced apart by a very small distance or by a certain distance. According to another embodiment, the outer circumferential surface of the inner nozzle part 10 may at least partly be in contact with the inner circumferential surface of the outer nozzle part 30. The inner nozzle part 10 comprises a plurality of inner nozzle recesses 12, which have arc-shaped cross sections and are disposed around the outer circumferential surface facing the outer nozzle part 30 in the circumferential direction. The outer nozzle part 30 comprises a plurality of outer nozzle recesses 32, which have arc-shaped cross sections and are disposed around the inner circumferential surface facing the inner nozzle part 10 in the circumferential direction.

The diameter of the inner nozzle part 10 (inner nozzle diameter, D1) is preferably 10 to 40 mm, more preferably 16 to 32 mm, even more preferably 16 to 24 mm, and most preferably 16 to 18 mm.

The opening diameter (D2) formed by the inner nozzle recess 12 and the outer nozzle recess 32 is preferably 0.5 to 5 mm, more preferably 1 to 3 mm, and even more preferably 2.0 to 2.4 mm.

The inner nozzle recess 12 and the outer nozzle recess 32 may each be present in a plural number. The numbers of the inner nozzle recess 12 and the outer nozzle recess 32 are preferably each 4 or more from the viewpoint of producing a cylindrical puffed snack food with a complex form, and preferably each 20 or less from the viewpoint of producing a cylindrical puffed snack food having a light texture. In other words, the numbers of the inner nozzle recess 12 and the outer nozzle recess 32 are preferably each 4 to 20. The numbers of the inner nozzle recess 12 and the outer nozzle recess 32 are more preferably each 6 to 16. From the viewpoint of producing a cylindrical puffed snack food capable of retaining an impact-resistant and complex form, the number of the inner nozzle recess 12 is preferably equal to that of the outer nozzle recess 32. From the viewpoint of producing a cylindrical puffed snack food within such a range that the light texture is not impaired, the number of the inner nozzle recess 12 is preferably greater than that of the outer nozzle recess 32.

The inner nozzle part 10 is fixed, while the outer nozzle part 30 continuously rotates in one direction. That is, the outer nozzle part 30 is mounted to be continuously rotatable around the inner nozzle part 10.

The cylindrical puffed snack food according to the present embodiment can be produced when the total length of the arcs of the recesses 12 formed around the inner nozzle part 10 is ⅓ or more and ¾ or less of the length of the circumference of the inner nozzle part 10 (3.14 times the inner nozzle diameter D1). Preferably, the total length of the arcs of the recesses 12 formed around the inner nozzle part 10 is ½ or more and ⅔ or less of the length of the circumference of the inner nozzle part 10. That is, the total length of the arcs of a plurality of the inner nozzle recesses 12 is ⅓ or more and ¾ or less, preferably ½ or more and ⅔ or less of the length of the circumference of the inner nozzle part 10. Designating the inner nozzle diameter as D1, the opening diameter formed by the inner nozzle recess 12 and the outer nozzle recess 32 as D2, and the number of the inner nozzle recess 12 as n, the die head 50 according to the present embodiment is a die head which satisfies the following formula (1), preferably formula (2).

(D1×3.14)×(⅓)×(n/2)×D2×3.14(D1×3.14)×(¾) Formula (1), and

(D1×3.14)×(½)×(n/2)×D2×3.14(D1×3.14)×(⅔) Formula (2).

The impregnated puffed snack food according to the present embodiment is an impregnated puffed snack food obtained by impregnating an oil and fat based confectionery material into the cylindrical puffed snack food. For example, the impregnated puffed snack food according to the present embodiment can be produced as follows.

Firstly, an oil and fat based confectionery material is prepared according to a conventional method (first step). In a case where the oil and fat based confectionery material is a chocolate material, for example, an ingredient composed of 21.0% by weight of cocoa mass, 32.2% by weight of sugar, 10.0% by weight of powdered milk, 7.5% by weight of cocoa butter, 28.0% by weight of vegetable oil and fat, 0.8% by weight of an emulsifier, and 0.5% by weight of a flavor can be used.

Secondly, the cylindrical puffed snack food according to the present embodiment fed in a basket is placed in a hermetically closed container, and the pressure is reduced to 0.008 MPa (which is in terms of the absolute pressure, when the absolute vacuum is 0 MPa). Thereafter, the basket is immersed in the oil and fat based confectionery material kept at 35° C., while the state of reduced pressure is maintained (second step).

Thirdly, the pressure is gradually released to return to the atmospheric pressure, and then the basket is taken out of the oil and fat based confectionery material (third step).

Fourthly, the cylindrical puffed snack food obtained by the above treatment is taken out of the hermetically closed container, and the excess of the oil and fat based confectionery material adhered to the surface of the cylindrical puffed snack food is removed by centrifugation separation (fourth step). The centrifuged cylindrical puffed snack is cooled at 15° C. to obtain an impregnated puffed snack food, which is a cylindrical puffed snack food impregnated with the oil and fat based confectionery material (chocolate material).

The impregnated puffed snack food according to the present embodiment, an additional impregnation step may be further added to the above series of impregnation process. For example, after releasing the pressure to return to the atmospheric pressure from the reduced pressure state of the second step, it is possible to add, between the second and third steps, an impregnation step comprising reducing pressure again, while maintaining the state in which the cylindrical puffed snack food is immersed in the oil and fat based confectionery material, and maintained the reduced pressure state for more than 0 to 20 seconds, and then the pressure is released to return to the atmospheric pressure. Further, after releasing the pressure to return to the atmospheric pressure from the reduced pressure state of the second step, it is also possible to add, between the second and third steps, an impregnation step comprising increasing the pressure by injecting compressed air and the like into the space inside the hermetically closed container, while maintaining the state in which the cylindrical puffed snack food is immersed in the oil and fat based confectionery material, and maintaining the above state for more than 0 to 20 seconds, and then returning the pressure to the atmospheric pressure. As another pressure operation method, it is also possible to adopt a method comprising increasing pressure first, followed by returning the pressure to the atmospheric pressure, or a method comprising increasing the pressure first, followed by reducing the pressure below the atmospheric pressure, and then returning the pressure again to the atmospheric pressure.

A method of impregnating an oil and fat based confectionery material into the cylindrical puffed snack food is not limited to the methods described above. For example, in the second step, impregnation of an oil and fat based confectionery material can also be carried out by the following procedure. First of all, the cylindrical puffed snack food according to the present embodiment fed in a basket is placed in a hermetically closed container, and then, the basket is immersed in an oil and fat based confectionery material kept at 35° C. Subsequently, the pressure inside the hermetically closed container is reduced to 0.008 MPa (which is in terms of the absolute pressure, absolute vacuum is 0 MPa). Then, the impregnated puffed snack food is obtained by carrying out the subsequent steps by similar methods to those described above.

The viscosity of the oil and fat based confectionery material according to the present embodiment is preferably 3000 to 15000 centipoise at 34° C. More preferably, the viscosity is 6000 to 10000 centipoise. In a case where oil and fat based confectionery material having a high viscosity is used, the viscosity is preferably adjusted to be in the range by adding an emulsifier as appropriate. The above viscosity indicates a viscosity as measured by a single cylindrical rotational viscometer (type-B viscometer) with a rotor No. 6 at a rotation speed of 4 r.p.m.

### EXAMPLES

The present invention will be more specifically described with reference to Examples below. However, the present invention is not limited to these Examples.

### Example 1

A puffed snack ingredient composed of 68.0 parts by weight of wheat flour, 16.8 parts by weight of starch, 5.2 parts by weight of sugar, 1.6 parts by weight of shortening, 1.0 part by weight of an emulsifier, and 0.2 part by weight of skim milk powder was supplied to a twin-screw extruder (Model TEM50B, the product of TOSHIBA MACHINE CO., LTD) under the conditions of a feed volume of 70 kg/hr and an amount of water added of 6.0 kg/hr. Subsequently, the puffed snack ingredient was kneaded, heated, and then pressurized under the conditions of a screw rotation speed of 400 r.p.m., a head pressure of 70 kgf/cm², and a barrel temperature of 180° C. A die head provided with an inner nozzle part having an inner nozzle diameter (D1) of 16 mm was mounted on the tip of the extruder. The die head had eight inner nozzle recesses and six outer nozzle recesses. The inner nozzle recess and outer nozzle recess were each semicircular recesses having an opening diameter (D2) of 2.4 mm. A cylindrical puffed snack was discharged while rotating the outer nozzle part, cut into approximately 50 mm pieces, and then left to cool until the product temperature reached room temperature, whereby a cylindrical puffed snack food was obtained.

The obtained cylindrical puffed snack food had a form in which six outer rope parts were generally concentrically laminated on eight inner rope parts, intersecting at approximately 20°. The obtained cylindrical puffed snack food had, as a whole, a substantially cylindrical form with a short side of approximately 20 mm×a long side of approximately 50 mm. The cylindrical puffed snack food was strong enough to withstand continuous production.

When the obtained cylindrical puffed snack food was eaten, it gave a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 2

In a similar manner to Example 1, the puffed snack ingredient was kneaded, heated, and then pressurized by the twin-screw extruder. A die head provided with an inner nozzle part having an inner nozzle diameter (D1) of 16 mm was mounted on the tip of the extruder. The die head had eight inner nozzle recesses and eight outer nozzle recesses. The inner nozzle recess and outer nozzle recess were each semicircular recesses having an opening diameter (D2) of 2.4 mm. A cylindrical puffed snack was discharged while rotating the outer nozzle part, cut into approximately 30 mm pieces, and then left to cool until the product temperature reached room temperature, whereby a cylindrical puffed snack food was obtained.

The obtained cylindrical puffed snack food had a form in which eight outer rope parts were generally concentrically laminated on eight inner rope parts, intersecting at approximately 15°. The obtained cylindrical puffed snack food had, as a whole, a substantially cylindrical form with a short side of approximately 20 mm×a long side of approximately 30 mm. The cylindrical puffed snack food was strong enough to withstand continuous production.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 3

In a similar manner to Example 1, the puffed snack ingredient was kneaded, heated, and then pressurized by the twin-screw extruder. A die head provided with an inner nozzle part having an inner nozzle diameter (D1) of 16 mm was mounted on the tip of the extruder. The die head had eight inner nozzle recesses and eight outer nozzle recesses. The inner nozzle recess and outer nozzle recess were each semicircular recesses having an opening diameter (D2) of 2.0 mm. A cylindrical puffed snack was discharged while rotating the outer nozzle part, cut into approximately 30 mm pieces, and then left to cool until the product temperature reached room temperature, whereby a cylindrical puffed snack food was obtained.

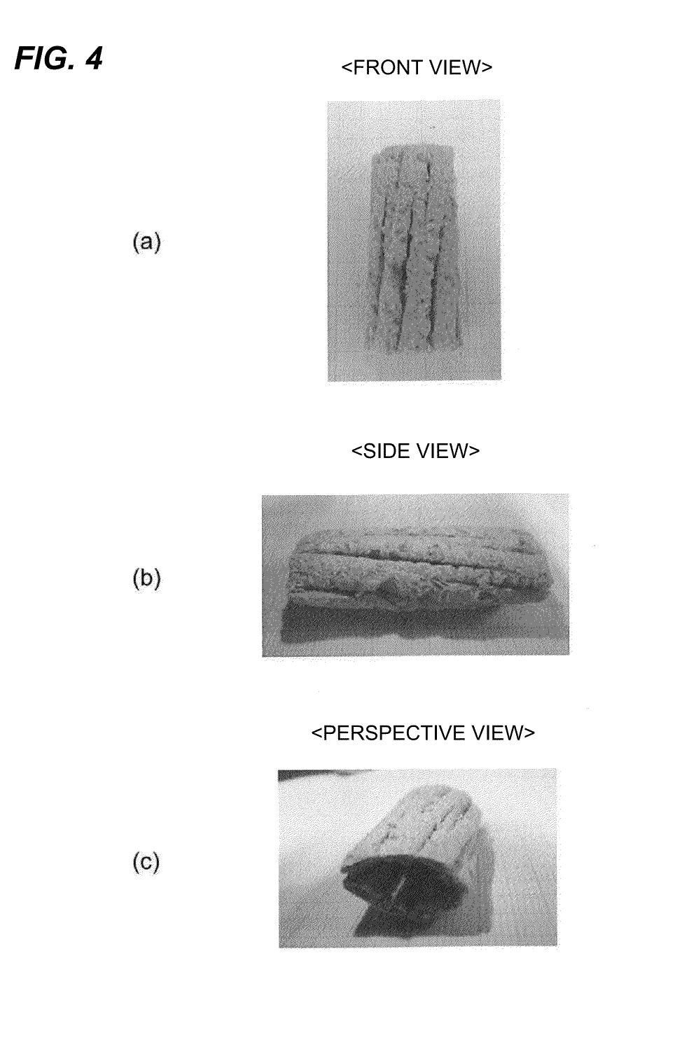

The obtained cylindrical puffed snack food had a form in which eight outer rope parts were generally concentrically laminated (in an oval form) on eight inner rope parts, intersecting at approximately 15°. The obtained cylindrical puffed snack food had, as a whole, a substantially cylindrical form with a short side of approximately 20 mm×a long side of approximately 30 mm. The cylindrical puffed snack food was strong enough to withstand continuous production. The photographs of the obtained cylindrical puffed snack food were shown in FIG. 4.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 4

A puffed snack ingredient composed of 72.5 parts by weight of wheat flour, 16.8 parts by weight of starch, 5.2 parts by weight of sugar, 1.6 parts by weight of shortening, 1.0 part by weight of an emulsifier, and 0.9 part by weight of skim milk powder was supplied to a twin-screw extruder (Model TEM50B, the product of TOSHIBA MACHINE CO., LTD) under the conditions of a feed volume of 63 kg/hr and an amount of water added of 5.5 kg/hr. Subsequently, the puffed snack ingredient was kneaded, heated, and then pressurized under the conditions of a screw rotation speed of 400 r.p.m., a head pressure of 69 kgf/cm2, and a barrel temperature of 180° C. A die head provided with an inner nozzle part having an inner nozzle diameter (D1) of 18 mm was mounted on the tip of the extruder. The die head had 10 inner nozzle recesses and six outer nozzle recesses. The inner nozzle recess and outer nozzle recess were each semicircular recesses having an opening diameter (D2) of 2.4 mm. A cylindrical puffed snack was discharged while rotating the outer nozzle part, cut into approximately 30 mm pieces, and then left to cool until the product temperature reached room temperature, whereby a cylindrical puffed snack food was obtained.

The obtained cylindrical puffed snack food had a form in which six outer rope parts were generally concentrically laminated on 10 inner rope parts, intersecting at approximately 25°. The obtained cylindrical puffed snack food had, as a whole, a substantially cylindrical form with a short side of 20 mm×a long side of 30 mm. The cylindrical puffed snack food was strong enough to withstand continuous production.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 5

In a similar manner to Example 4, the puffed snack ingredient was kneaded, heated, and then pressurized by the twin-screw extruder. A die head provided with an inner nozzle part having an inner nozzle diameter (D1) of 18 mm was mounted on the tip of the extruder. The die head had 10 inner nozzle recesses and eight outer nozzle recesses. The inner nozzle recess and outer nozzle recess were each semicircular recesses having an opening diameter (D2) of 2.4 mm. A cylindrical puffed snack was discharged while rotating the outer nozzle part, cut into approximately 30 mm pieces, and then left to cool until the product temperature reached room temperature, whereby a cylindrical puffed snack food was obtained.

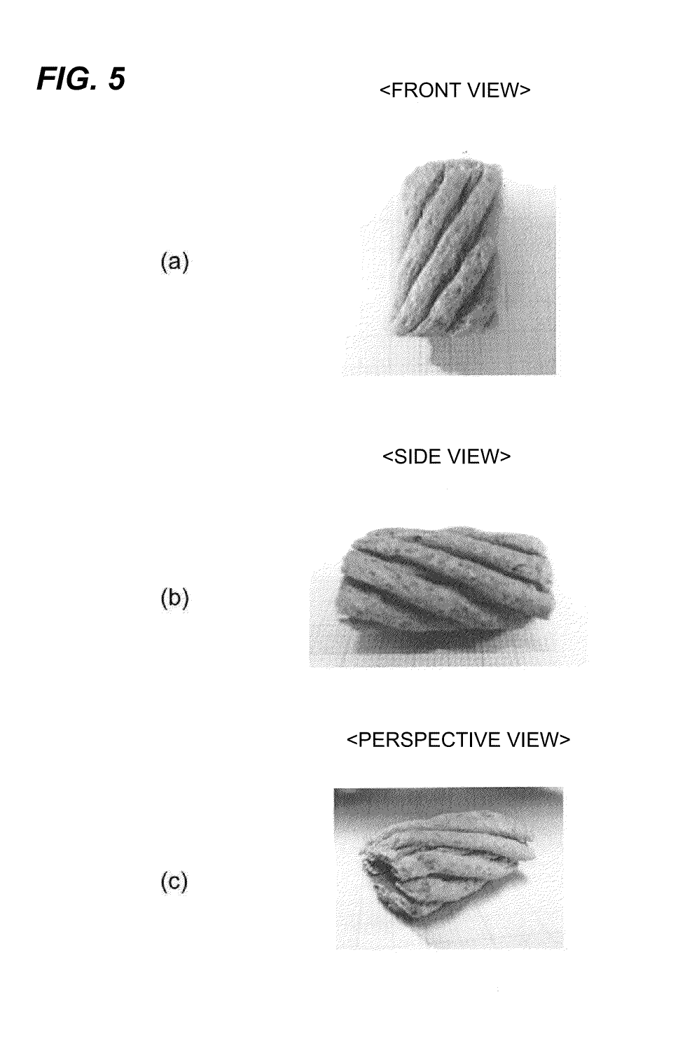

The obtained cylindrical puffed snack food had a form in which eight outer rope parts were generally concentrically laminated (in an oval form) on 10 inner rope parts, intersecting at approximately 30°. The obtained cylindrical puffed snack food had, as a whole, a substantially cylindrical form with a short side of approximately 20 mm×a long side of approximately 30 mm. The cylindrical puffed snack food was strong enough to withstand continuous production. The photographs of the obtained cylindrical puffed snack food were shown in FIG. 5.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 6

A puffed snack ingredient composed of 74.8 parts by weight of wheat flour, 10.0 parts by weight of starch, 5.2 parts by weight of sugar, 1.6 parts by weight of shortening, and 1.2 parts by weight of an emulsifier was supplied to a twin-screw extruder (Model TEM50B, the product of TOSHIBA MACHINE CO., LTD) under the conditions of a feed volume of 60 kg/hr and an amount of water added of 5.0 kg/hr. Subsequently, the puffed snack ingredient was kneaded, heated, and then pressurized under the conditions of a screw rotation speed of 390 r.p.m., a head pressure of 68 kgf/cm², and a barrel temperature of 160° C. A die head provided with an inner nozzle part having an inner nozzle diameter (D1) of 24 mm was mounted on the tip of the extruder. The die head had 12 inner nozzle recesses and 10 outer nozzle recesses. The inner nozzle recess and outer nozzle recess were each semicircular recesses having an opening diameter (D2) of 2.0 mm. A cylindrical puffed snack was discharged while rotating the outer nozzle part, cut into approximately 40 mm pieces, and then left to cool until the product temperature reached room temperature, whereby a cylindrical puffed snack food was obtained.

The obtained cylindrical puffed snack food had a form in which 10 outer rope parts were generally concentrically laminated on 12 inner rope parts, intersecting at approximately 30°. The obtained cylindrical puffed snack food had, as a whole, a substantially cylindrical form with a short side of approximately 30 mm×a long side of approximately 40 mm. The cylindrical puffed snack food was strong enough to withstand continuous production.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Example 7

In a similar manner to Example 1, a puffed snack ingredient composed of 70.8 parts by weight of wheat flour, 12.5 parts by weight of starch, 5.0 parts by weight of sugar, 1.8 parts by weight of shortening, 1.0 part by weight of an emulsifier, and 3.5 parts by weight of skim milk powder was kneaded, heated, and pressurized by the twin-screw extruder. A die head provided with an inner nozzle part having an inner nozzle diameter (D1) of 32 mm was mounted on the tip of the extruder. The die head had 16 inner nozzle recesses and 16 outer nozzle recesses. The inner nozzle recess and outer nozzle recess were each semicircular recesses having an opening diameter (D2) of 2.0 mm. A cylindrical puffed snack was discharged while rotating the outer nozzle part, cut into approximately 35 mm pieces, and then left to cool until the product temperature reached room temperature, whereby a cylindrical puffed snack food was obtained.

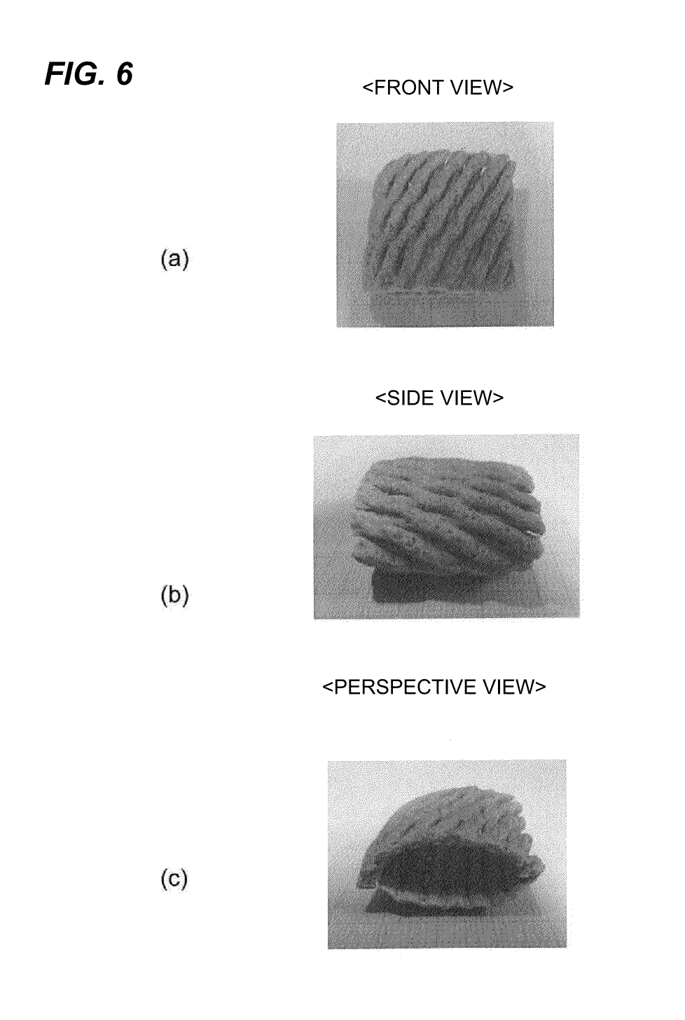

The obtained cylindrical puffed snack food had a form in which 16 outer rope parts were generally concentrically laminated (in a lens form) on 16 inner rope parts, intersecting at approximately 35°. The obtained cylindrical puffed snack food had, as a whole, a substantially cylindrical form with a short side of approximately 35 mm×a long side of approximately 35 mm. The cylindrical puffed snack food was strong enough to withstand continuous production. The photographs of the obtained cylindrical puffed snack food were shown in FIG. 6.

When the obtained cylindrical puffed snack food was eaten, it had a light crispness when chewed, despite its complex form. The obtained cylindrical puffed snack food crumbled in a brittle manner when chewed, readily melting in the mouth. Further, because the obtained cylindrical puffed snack food crumbled in a complex way in the mouth when chewed, it gave a unique texture, which was characterized not simply by a crispy texture.

### Comparative Example 1

In a similar manner to Example 1, a puffed snack ingredient composed of 73.3 parts by weight of wheat flour, 16.8 parts by weight of starch, 5.2 parts by weight of sugar, 1.6 parts by weight of shortening, 1.0 part by weight of an emulsifier, and 0.05 part by weight of skim milk powder was kneaded, heated, and pressurized by the twin-screw extruder. A die head provided with an inner nozzle part having an inner nozzle diameter (D1) of 18 mm was mounted on the tip of the extruder. The die head had 15 inner nozzle recesses and eight outer nozzle recesses. The inner nozzle recess and outer nozzle recess were each semicircular recesses having an opening diameter (D2) of 2.4 mm. A puffed snack was discharged while rotating the outer nozzle part; however, a form in which inner rope parts and outer rope parts were generally concentrically laminated, intersecting with each other, could not be formed. In more detail, the outer rope parts produced by the die head were too thin to bundle the inner rope parts. Depending on the operating conditions, however, the outer rope parts were able to bundle the inner rope parts immediately after discharge from the extruder. Nevertheless, after that, the puffed snack could not hold a form in which the inner rope parts and outer rope parts were generally concentrically laminated, ending up crumbling during the process of cutting into the desired length.

Puffed snack ingredients and operating conditions of the extruder were further studied. However, no cylindrical puffed snack in which inner rope parts and outer rope parts were generally concentrically laminated, intersecting with each other, was successfully obtained under any condition studied.

### Comparative Example 2

In a similar manner to Example 1, a puffed snack ingredient composed of 74.8 parts by weight of wheat flour, 16.8 parts by weight of starch, 52 parts by weight of sugar, 1.6 parts by weight of shortening, and 0.1 part by weight of an emulsifier was kneaded, heated, and pressurized by the twin-screw extruder. A die head provided with an inner nozzle part having an inner nozzle diameter (M) of 18 mm was mounted on the tip of the extruder. The die head had 20 inner nozzle recesses and eight outer nozzle recesses. The inner nozzle recess was a 120° arc-shaped recess with an opening diameter (D2) of 2.4 mm. The outer nozzle recess was semicircular recesses having an opening diameter (D2) of 2.4 mm. A puffed snack was discharged while rotating the outer nozzle part; however, a form in which inner rope parts and outer rope parts were generally concentrically laminated, intersecting with each other, could not be formed. In more detail, with the die head, the inner rope parts and outer rope parts were integrated in a plate-like form, failing in creating a form in which the inner rope parts and outer rope parts were generally concentrically laminated.

Puffed snack ingredients and operating conditions of the extruder were further studied. However, no cylindrical puffed snack in which the inner rope parts and outer rope parts were generally concentrically laminated, intersecting with each other, was successfully obtained under any condition studied.

### Examples 8 to 14

Using an oil and fat based confectionery material ingredient composed of 21.0% by weight of cocoa mass, 32.2% by weight of sugar, 10.0% by weight of powdered milk, 7.5% by weight of cocoa butter, 28.0% by weight of vegetable oil and fat, 0.8% by weight of an emulsifier, and 0.5% by weight of a flavor, an oil and fat based confectionery material (chocolate material) was prepared in accordance with a routine method.

The cylindrical puffed snack foods obtained in Examples 1 to 7 were each fed in baskets, and then the baskets were placed in hermetically closed containers, and the pressure was reduced to 0.008 MPa (which is in terms of the absolute pressure, when the absolute vacuum is 0 MPa). Thereafter, the baskets were immersed in the chocolate material kept at 35° C., while maintaining the reduced pressure state. Upon completion of immersion, the pressure was gradually released to return to the atmospheric pressure, and the baskets were taken out of the chocolate material. The cylindrical puffed snack foods treated as above were taken out of the hermetically closed containers, and excess of the oil and fat based confectionery material adhered to the surface of the cylindrical puffed snack foods was removed by centrifugation separation. After centrifugation, the resulting products were cooled at 15° C., whereby impregnated puffed snack foods impregnated with the chocolate material (Examples 8 to 14, respectively) were obtained. The cylindrical puffed snack foods obtained in Examples 1 to 7 were all strong enough to withstand impregnation treatment.

In all of the impregnated puffed snack foods obtained, the porous cylindrical puffed snacks were impregnated with the chocolate material, and upon eating, chocolate and puffed snacks were felt integrated. Despite being impregnated with chocolate material, the impregnated puffed snack foods had a light crispness when chewed and crumbled in a brittle manner when chewed, readily melting in the mouth. Further, because the impregnated puffed snack foods crumbled in a complex way in the mouth when chewed, they gave a unique texture, which was characterized not simply by a crispy texture.

When the impregnated puffed snack foods obtained in Examples 8, 9, 11, and 12 were cut in the center of the long side, it was confirmed that the chocolate material not only attached to the surface of the puffed snacks, but also impregnated into the inner rope parts and outer rope parts of the puffed snacks. When the impregnated puffed snack foods obtained in Examples 10 and 13 were cut in the center of the long side, it was confirmed that the chocolate material impregnated also into the inner rope parts and outer rope parts of the puffed snacks. Comparing with the impregnated puffed snack foods obtained in Examples 8, 9, 11, and 12, the degree of impregnation of chocolate material into the impregnated puffed snack foods obtained in Examples 10 and 13 was generally lower.

Meanwhile, because the cylindrical puffed snack food (Example 7) used in Example 14 was produced with a die head having the longest inner nozzle diameter among Examples 1 to 7, the above cylindrical puffed snack food would have the largest surface area when all the cylindrical puffed snack foods were cut into the same long side length. It was speculated that when a chocolate material was impregnated into such a cylindrical puffed snack food that was produced in Example 7, the amount of the chocolate material impregnated would be at least greater than the amount of the chocolate material impregnated into the impregnated puffed snack foods obtained in Examples 10 and 13. However, when the impregnated puffed snack food actually obtained in Example 14 was cut in the center of the long side, it was confirmed that the amount of the chocolate material impregnated into the inner rope parts and outer rope parts of the puffed snack was less than the amount of the chocolate material impregnated into the impregnated puffed snack foods obtained in Examples 10 and 13. These results were unexpected by those skilled in the art, although the reason accounting for this remains unclear.

As shown above, a puffed snack food having an unprecedentedly complex form which had a light texture, despite its complex form was successfully obtained. An impregnated puffed snack food impregnated with an oil and fat based confectionery material, despite its complex form, was successfully obtained. Further, an impregnated puffed snack food having a light texture, despite being impregnated with an oil and fat based confectionery material, was successfully obtained.

### REFERENCE SIGNS LIST

1: inner rope part, 2: outer rope part, 10: inner nozzle part, 12: inner nozzle recess, 30: outer nozzle part, 32: outer nozzle recess, 50: die head, 100: cylindrical puffed snack food.

1. A cylindrical puffed snack food comprising a plurality of inner rope parts and a plurality of outer rope parts,
wherein the inner rope parts and the outer rope parts are formed by using a die head comprising a circular inner nozzle part and an annular outer nozzle part provided around the inner nozzle part,
wherein the inner nozzle part comprises a plurality of inner nozzle recesses, which have arc-shaped cross sections and are disposed around an outer circumferential surface facing the outer nozzle part in the circumferential direction,
the outer nozzle part comprises a plurality of outer nozzle recesses, which have arc-shaped cross sections and are disposed around an inner circumferential surface facing the inner nozzle part in the circumferential direction,
the outer nozzle part is provided in such a way as to be continuously rotatable around the inner nozzle part, and
a total length of the arcs of the plurality of inner nozzle recesses is ⅓ or more and ¾ or less of a length of a circumference of the inner nozzle part, and
wherein the cylindrical puffed snack food is obtained by a method comprising a step of molding a puffed snack ingredient by extrusion through the die head.

2. The cylindrical puffed snack food according to claim 1, wherein a diameter of the inner rope part and a diameter of the outer rope part are each 0.5 mm to 5 mm.

3. The cylindrical puffed snack food according to claim 1, wherein the puffed snack ingredient comprising 50 parts by weight to 100 parts by weight of a starchy ingredient, 0.1 part by weight to 10 parts by weight of a protein ingredient, 0.5 part by weight to 10 parts by weight of an oil and fat ingredient, and 8 parts by weight to 20 parts by weight of water is puffed by an extruder provided with the die head.

4. An impregnated puffed snack food which is a cylindrical puffed snack food comprising a plurality of inner rope parts and a plurality of outer rope parts impregnated with an oil and fat based confectionery material,
wherein the inner rope parts and the outer rope parts are formed by using a die head comprising a circular inner nozzle part and an annular outer nozzle part provided around the inner nozzle part,
wherein the inner nozzle part comprises a plurality of inner nozzle recesses, which have arc-shaped cross sections and are disposed around an outer circumferential surface facing the outer nozzle part in the circumferential direction,
the outer nozzle part comprises a plurality of outer nozzle recesses, which have arc-shaped cross sections and are disposed around an inner circumferential surface facing the inner nozzle part in the circumferential direction,
the outer nozzle part is provided in such a way as to be continuously rotatable around the inner nozzle part, and
a total length of the arcs of the plurality of inner nozzle recesses is ⅓ or more and ¾ or less of a length of a circumference of the inner nozzle part, and
wherein the cylindrical puffed snack food is obtained by a method comprising a step of molding a puffed snack ingredient by extrusion through the die head.

5. The impregnated puffed snack food according to claim 4, wherein a diameter of the inner rope part and a diameter of the outer rope part are each 1 mm to 5 mm.

6. The impregnated puffed snack food according to claim 4, wherein the puffed snack ingredient comprising 50 parts by weight to 100 parts by weight of a starchy ingredient, 0.1 part by weight to 10 parts by weight of a protein ingredient, 0.5 part by weight to 10 parts by weight of an oil and fat ingredient, and 8 parts by weight to 20 parts by weight of water is puffed by an extruder provided with the die head.
